(19) United States
(12) Patent Application Publication
(10) Pub. No.: US 2025/0041149 A1
(43) Pub. Date: Feb. 6, 2025

(54) LAMINATED AIR BAG

(71) Applicant: Shenzhen Dongjilian Medical Tech Co., Ltd., Shenzhen (CN)

(72) Inventor: Hong Zhang, Shenzhen (CN)

(21) Appl. No.: 18/767,707

(22) Filed: Jul. 9, 2024

(30) Foreign Application Priority Data
Aug. 4, 2023 (CN) 2023220990564

(51) Int. Cl. A61H 9/00

(52) U.S. Cl. CPC A61H 9/0092; A61H 2201/1645; A61H 2205/10; A61H 2209/00

(57) ABSTRACT

The invention discloses a laminated air bag, including an outer fabric layer. An air bag assembly is fixed to the inner surface of the outer fabric layer by means of a hot-pressing mode. The air bag assembly is formed by staggered laminating of a thigh sheet, a knee-joint sheet, a shank sheet, and a sole sheet from top to bottom. A plurality of closed spaces satisfying air inflation are formed between the thigh sheet, the knee-joint sheet, the shank sheet and the sole sheet as well as the outer fabric layer that are encircled. An inflatable connecting assembly is arranged at the outer end of the outer fabric layer. The inflatable connecting assembly includes a connecting plug, an air-tube adapter, and four air tubes connected in sequence.

### CROSS-REFERENCE TO RELATED APPLICATIONS

The application claims priority to Chinese patent application No. 202322099056.4, filed on Aug. 4, 2023, the entire contents of which are incorporated herein by reference.

### TECHNICAL FIELD

The invention belongs to the technical field of medical and healthcare products, and specifically relates to a laminated air bag.

### BACKGROUND

Venous thrombosis is a common peripheral vascular disease that can lead to venous valve insufficiency and concomitant pulmonary embolism, which is a major risk to patient's labor and life safety. This disease has been highly paid more attention clinically. The general venous thrombosis occurs in lower limbs, legs, feet, and the like, which requires frequent massage, to promote the circulation of blood, and alleviate conditions. Currently, an inflatable leg sleeve is generally used for massaging the lower limbs.

Currently, a traditional leg sleeve wraps the lower limb part on both sides. In the process of use, the feet, the legs, and knees are poorly fitted by the leg sleeve, which affects the use of the leg sleeve. In addition, when the traditional leg sleeve is inflated, each air bag is presented as a separate bulge (as shown in FIG. 6, a left figure), which leads to gaps at connecting places between the bulges. Therefore, the part of the air bag is not fully adhered to the lower limb part, which affects the quality of the overall massage, and hence makes it unable to meet a user's needs for use.

### SUMMARY

To overcome the drawbacks of the prior art, the objective of this invention is to provide a laminated air bag.

The technical solution adopted in this invention is as follows: a laminated air bag includes an outer fabric layer. An air bag assembly is fixed to the inner surface of the outer fabric layer by means of a hot-pressing mode. The air bag assembly is formed by staggered laminating of a thigh sheet, a knee-joint sheet, a shank sheet and a sole sheet from top to bottom. A plurality of closed spaces satisfying air inflation are formed between the thigh sheet, the knee-joint sheet, the shank sheet and the sole sheet as well as the outer fabric layer that are encircled. An inflatable connecting assembly is arranged at the outer end of the outer fabric layer.

In a preferred embodiment, the inflatable connecting assembly includes a connecting plug, an air-tube adapter, and four air tubes connected in sequence.

In a preferred embodiment, inflatable holes in communication with the plurality of closed spaces are formed in the outer fabric layer, and the four air tubes are connected to the plurality of inflatable holes, respectively.

In a preferred embodiment, the air bag assembly is made of a TPU material, and the thigh sheet, the knee-joint sheet, the shank sheet, and the sole sheet are fixed together by means of a hot-pressing mode.

In a preferred embodiment, an inner fabric layer is arranged at the inner end of the air bag assembly. The inner fabric layer is sewn at the inner end of the outer fabric layer for wrapping the air bag assembly, and the inner fabric layer is made of memory cloth.

In a preferred embodiment, the outer fabric layer is made of a 210D composite material, and a decorative layer is sewn at the outer fabric layer at the outer end of the air tube.

In a preferred embodiment, the shape and the size of the air bag assembly and the shape and the size of the inner fabric layer are adapted to the shape and the size of the outer fabric layer.

In a preferred embodiment, an air pump is detachably mounted at the head end of the connecting plug.

In summary, due to the adoption of the above technical solution, the beneficial effects of the invention are as follows:
1. In the invention, the plurality of air bags is partially laminated so that a low-arc surface can be compensated, thereby achieving the effect of full wrapping. Therefore, the all-around fitting massage of a leg can be realized, and every part of the leg can enjoy the effect of the massage, enabling more comfortable massage. The laminated air bag increases the ability to promote the circulation of blood, and can effectively alleviate the fatigue of the leg.
2. In the invention, the overall air bag is designed to have the size and the shape that conform to those of the outside fabric layer so that the leg can be fully wrapped, and a massage effect is better.
3. In the invention, the air bag assembly is made of the TPU material instead of a traditional 210D material, which is lower in cost and more concise in processing. The inner fabric layer is made of softer and more comfortable memory cloth, which is more comfortable to use.

### BRIEF DESCRIPTION OF DRAWINGS

FIG. 1 shows an overall exploded three-dimensional schematic structural diagram of the invention;

FIG. 2 shows an exploded three-dimensional schematic structural diagram of an air bag assembly and an outer fabric layer of the invention that are combined;

FIG. 3 shows a sectional three-dimensional schematic structural diagram of the combination of an air bag assembly and an outer fabric layer of the invention after being combined and inflated;

FIG. 4 shows a side planar schematic structural diagram of the invention after the overall combination;

FIG. 5 shows an exploded three-dimensional simplified schematic structural diagram of an inflatable connecting assembly of the invention;

FIG. 6 shows, from left to right, a simple schematic structural diagram of an existing air bag part and an existing leg part combined as well as an air bag part and a leg part combined of the invention.

Reference signs in the figures: 1—inner fabric layer, 2—air bag assembly, 201—thigh sheet, 202—knee-joint sheet, 203—shank sheet, 204—sole sheet, 3—outer fabric layer, 301—inflatable hole, 4—decorative layer, 5—inflatable connecting assembly, 501—connecting plug, 502—air-tube adapter, 503—air tube.

### DETAILED DESCRIPTION OF THE EMBODIMENTS

The invention is described in further detail below in conjunction with the embodiments in comparison with the accompanying drawings.

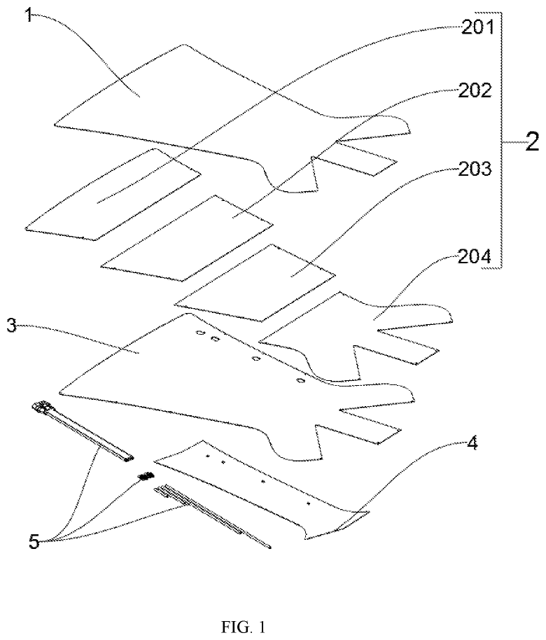

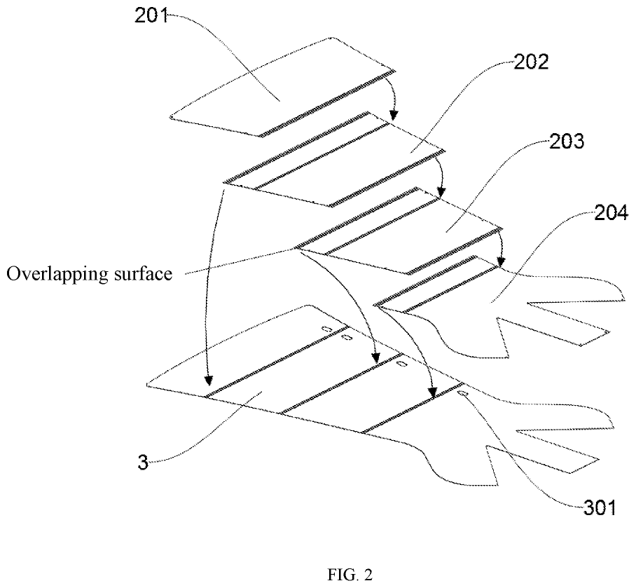

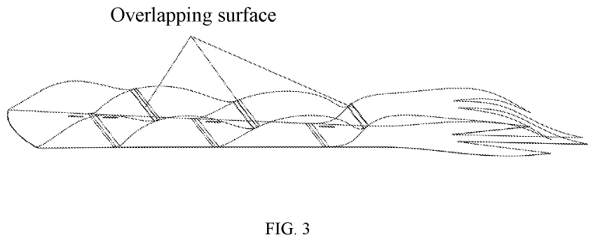

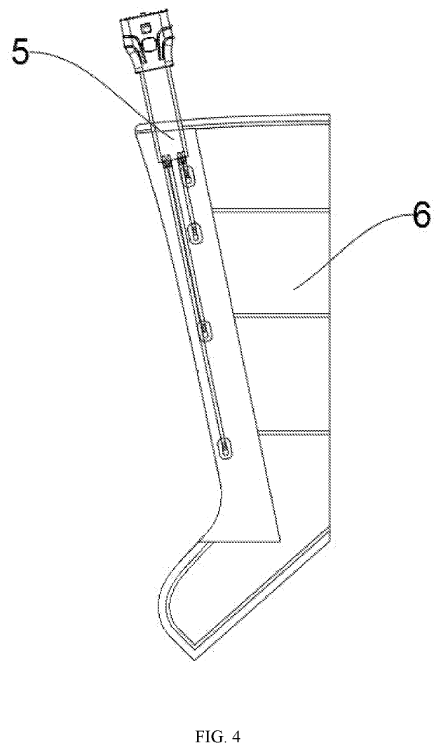

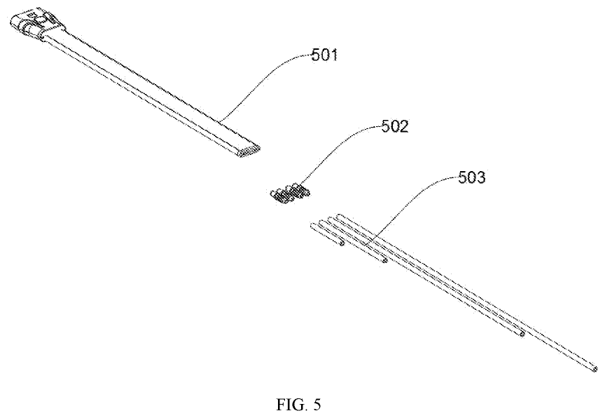

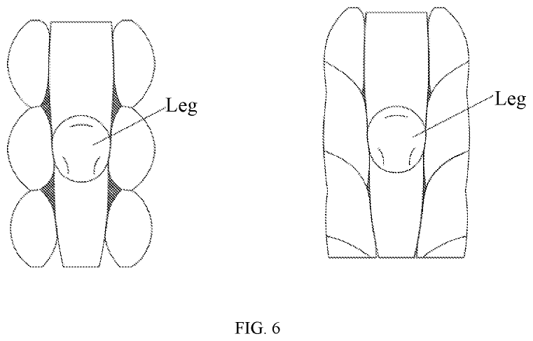

Referring to FIGS. 1-6, a laminated air bag includes an outer fabric layer 3. An air bag assembly 2 is fixed to the inner surface of the outer fabric layer 3 by means of a hot-pressing mode. The air bag assembly 2 is formed by staggered laminating of a thigh sheet 201, a knee-joint sheet 202, a shank sheet 203, and a sole sheet 204 from top to bottom. A plurality of closed spaces satisfying air inflation are formed between the thigh sheet 201, the knee-joint sheet 202, the shank sheet 203 and the sole sheet 204 as well as the outer fabric layer 3 that are encircled. The sheet parts of the air bag assembly 2 are staggered and laminated so that a low-arc place can be compensated, thereby achieving the effect of full wrapping. Therefore, the all-around fitting massage of a leg can be realized, and every part of the leg can enjoy the effect of the massage, enabling more comfortable massage. The laminated air bag increases the ability to promote the circulation of blood, and can effectively alleviate the fatigue of the leg.

Specifically, a leg sleeve is divided into left and right ones, which are sleeved onto a user's legs to complete a combination operation.

In this embodiment, the inflatable connecting assembly 5 includes a connecting plug 501, an air tube adapter 502, and four air tubes 503 (each has different lengths) connected in sequence. The inflatable connecting assembly 5 is arranged at the outer end of the outer fabric layer 3. Inflatable holes 301 in communication with a plurality of closed spaces are formed in the outer fabric layer 3. The four air tubes 503 are connected to the plurality of inflatable holes 301. An air pump is detachably mounted at the head end of the connecting plug 501. When in use, the air pump is externally connected to a power source. Then, the constituted closed spaces are inflated and pumped by the air pump. The expansion and retraction of the air bag assembly 2 is utilized for massaging a lower limb part to promote the circulation of blood and to prevent the formation of venous thrombosis. Inflatable massage effectively prevents the formation of the venous thrombosis, and at the same time, is able to ensure that the laminated air bag can be used for a long period of time continuously anytime and anywhere.

The air pump 501 is a pumping and suctioning dual-purpose air pump.

In this embodiment, the air bag assembly 2 is made of a TPU material. The thigh sheet 201, the knee-joint sheet 202, the shank sheet 203, and the sole sheet 204 are all fixed together by means of a hot-pressing mode. An inner fabric layer 1 is arranged at the inner end of the air bag assembly 2. The inner fabric layer 1 is sewn at the inner end of the outer fabric layer 3 and is used for wrapping the air bag assembly 2. The inner fabric layer 1 is made of memory cloth. The air bag assembly 2 is made of the TPU material instead of a traditional 210D material, which is lower in cost and more concise in processing. The inner fabric layer 1 is made of softer and more comfortable memory cloth, which is more comfortable in use.

It should also be mentioned that a heating function can also be added overall, which is realized simply by sewing a soft heating sheet onto the inner fabric layer 1 (not shown in the figure). The cost is lower than other fully wrapped leg sleeves with heating on the market.

In this embodiment, the outer fabric layer 3 is made of a 210D composite material. A decorative layer 4 is sewn at the outer fabric layer 3 at the outer end of the air tube 503. The decorative layer 4 can ensure aesthetics while hiding and assisting in positioning the air tube 503.

In this embodiment, the shape and the size of the air bag assembly 2 and the shape and the size of the inner fabric layer 1 are adapted to the shape and the size of the outside fabric layer 3. The overall air bag is designed to have the size and the shape that conform to those of the outside fabric layer so that the leg can be fully wrapped, and a massage effect is better.

In particular, it should be noted that the above process can also be used in an arm part. That is, the air bag is designed into the shape of an arm sleeve.

In this invention, the air bags are partially laminated so that a low-arc surface can be compensated, thereby achieving the effect of full wrapping. Therefore, the all-around fitting massage of a leg can be realized, and every part of the leg can enjoy the effect of the massage, enabling more comfortable massage. The laminated air bag increases the ability to promote the circulation of blood, and can effectively alleviate the fatigue of the leg, making the overall use effect better.

The foregoing descriptions are only preferred embodiments of the invention, and are not intended to limit the invention. Any modification, equivalent replacement and improvement made within the spirit and principle of the invention shall be included within the protection scope of the invention

What is claimed is:

1. A laminated air bag, comprising:
an outer fabric layer, wherein an air bag assembly is fixed to an inner surface of the outer fabric layer by means of a hot-pressing mode;
the air bag assembly is formed by staggered laminating of a thigh sheet, a knee-joint sheet, a shank sheet, and a sole sheet from top to bottom;
a plurality of closed spaces satisfying air inflation are formed between the thigh sheet, the knee-joint sheet, the shank sheet and the sole sheet as well as the outer fabric layer that are encircled; and
an inflatable connecting assembly is arranged at an outer end of the outer fabric layer.

2. The laminated air bag according to claim 1, wherein the inflatable connecting assembly comprises a connecting plug, an air-tube adapter, and four air tubes connected in sequence.

3. The laminated air bag according to claim 2, wherein inflatable holes in communication with the plurality of closed spaces are formed in the outer fabric layer, and the four air tubes are connected to the plurality of inflatable holes, respectively.

4. The laminated air bag according to claim 1, wherein the air bag assembly is made of a TPU material, and the thigh sheet, the knee-joint sheet, the shank sheet, and the sole sheet are fixed together by means of the hot-pressing mode.

5. The laminated air bag according to claim 1, wherein an inner fabric layer is arranged at an inner end of the air bag assembly, the inner fabric layer is sewn at an inner end of the outer fabric layer for wrapping the air bag assembly, and the inner fabric layer is made of memory cloth.

6. The laminated air bag according to claim 1, wherein the outer fabric layer is made of a 210D composite material, and a decorative layer is sewn at the outer fabric layer at an outer end of the air tube.

7. The laminated air bag according to claim 5, wherein a shape and a size of the air bag assembly and a shape and a size of the inner fabric layer are adapted to a shape and a size of the outer fabric layer.

8. The laminated air bag according to claim 1, wherein an air pump is detachably mounted at a head end of the connecting plug.
